(19) United States
(12) Patent Application Publication
(10) Pub. No.: US 2019/0035394 A1
(43) Pub. Date: Jan. 31, 2019

(54) PROACTIVE CHATTING APPARATUS

(71) Applicant: INTEGRAL SEARCH INTERNATIONAL LIMITED, Taipei City (TW)

(72) Inventor: Hong-Shin Tsai, Taipei City (TW)

(73) Assignee: INTEGRAL SEARCH INTERNATIONAL LIMITED, Taipei City (TW)

(21) Appl. No.: 15/885,617

(22) Filed: Jan. 31, 2018

(30) Foreign Application Priority Data
Jul. 25, 2017 (TW) 106124814

(51) Int. Cl. G10L 15/22; G06F 17/30; G10L 15/18; G10L 15/24; G10L 15/30; G06K 9/00; G06F 3/16

(52) U.S. Cl. CPC G10L 15/22; G10L 2015/227; G06F 17/30525; G06F 17/30401; G06F 17/30259; G10L 15/1815; G10L 15/24; G10L 15/30; G06K 9/00302; G06K 9/00255; G06F 3/16; G06K 9/00845; G06K 9/00791; G10L 2015/223; G06F 17/30528

(57) ABSTRACT

A proactive chatting apparatus includes: a chat activation determining device determining whether a proactive chatting state is to be activated according to a facial expression image of a user or a user command from the user such that a proactive chatting signal is sent; a topic selecting device grabbing topic data of a topic item from a topic database according to the proactive chatting signal; a voice transceiver device receiving the topic data so as to proactively play the topic data to the user in way of voice, and receiving a voice response from the user in response to the topic data in such a manner that a chat conversation with the user is continued. Accordingly, the proactive chatting apparatus can proactively propose a voice signal to the user so as to initiate a chat conversation with the user.

### CROSS-REFERENCE TO RELATED APPLICATION

This application claims the benefit and priority of a Republic of China Patent Application No. 106124814 filed on Jul. 25, 2017.

### FIELD OF THE INVENTION

The present invention relates to a voice interactive system, and more particularly relates to a proactive chatting apparatus.

### BACKGROUND OF THE INVENTION

With the development of voice recognition technology, a voice interactive system has been implemented to achieve a natural conversation with a user. The conventional voice interactive systems including Siri, Cortana, etc, however, are limited as passive responding devices to which the conversation is started by the user and the replies from these voice interactive systems are generated after the user asks questions or makes requests. As a result, for example when the user feels sleepy while driving or when the user is getting bored but forgets to turn on these voice interactive systems, these voice interactive systems cannot proactively chat with the user. Furthermore, the chatting system of the prior arts cannot correctly choose a chatting topic according to a habit of the user or according to the environment where the user is located such that conversation cannot be performed in a way as natural as and as interesting as the daily conversation between people.

### SUMMARY OF THE INVENTION

Therefore, an objective of the present invention is to provide a proactive chatting apparatus which can automatically and proactively initiate a chat conversation with users. In addition, the proactive chatting apparatus of the present invention can choose a chatting topic more interested for the users.

In order to achieve the above, the present invention provides a proactive chatting apparatus adapted for use to proactively propose a voice signal to a user so as to initiate a chat conversation with the user, the proactive chatting apparatus comprising: a chat activation determining device determining whether a proactive chatting state is to be activated according to a facial expression image of the user or a user command from the user such that, when the chat activation determining device determines the current status as a chat activation state, a proactive chatting signal is sent; a topic selecting device grabbing topic data of a topic item from a topic database according to the proactive chatting signal; and a voice transceiver device being connected to the topic selecting device to receive the topic data grabbed by the topic selecting device so as to proactively play the topic data to the user in way of voice, and receive a voice response from the user in response to the topic data in such a manner that a chat conversation with the user is continued, wherein the topic items in the topic database are ones selected from a group comprising a current event item, a life background item, a travel destination item, a hobby item, a knowledge-acquiring item, a group instant-messaging topic item and a surrounding environment instant user topic item.

In one embodiment of the present invention, a proactive chatting apparatus is provided that the chat activation determining device is provided with a camera to obtain the facial expression image of the user.

In one embodiment of the present invention, a proactive chatting apparatus is provided that the chat activation determining device is provided with a camera to obtain the facial expression image of the user.

In one embodiment of the present invention, a proactive chatting apparatus is provided that the user command is a voice command or a key command.

In one embodiment of the present invention, a proactive chatting apparatus further comprising an interior car scenario judging device which is provided with an interior car scenario camera to obtain an interior car image inside a car where the user is, the topic selecting device grabbing the topic data of the topic item from the topic database according to the interior car image.

In one embodiment of the present invention, a proactive chatting apparatus further comprising an exterior car scenario judging device which is provided with an exterior car scenario camera to obtain an exterior car image outside the car where the user is, the topic selecting device grabbing the topic data of the topic item from the topic database according to the exterior car image.

In one embodiment of the present invention, a proactive chatting apparatus is provided that the topic data includes a plurality of topic data, and the plurality of topic data are related to each other.

In one embodiment of the present invention, a proactive chatting apparatus is provided that the chat activation determining device determines whether the proactive chatting state is to be terminated according to the user facial expression image of the user or according to the user command from the user so as to terminate the chat conversation.

In one embodiment of the present invention, a proactive chatting apparatus further comprising an exterior chatting device which receives a voice signal from other users outside the car where the user is so as to initiate the chat conversation between the user and said other users.

By technical means adopted by the proactive chatting apparatus of the present invention, the proactive chatting apparatus installed inside a car can proactively initiate a chat with a car driver to refresh the car driver from falling asleep or even from feeling sleepy. In addition, the topic of the proactive chat can be closer to users' interest, since the proactive chatting apparatus can search for topic data before the chat conversation is proactively initialized. Since a content of the chat conversation is not limited to requests or questions that the user asks, the content of the chat conversation can be more diverse. Preferably, the proactive chatting apparatus can choose the chatting topic according to the habit of the user so as to initiate a chat conversation which is similar to the natural daily conversation between people. In view of the above, the proactive chatting apparatus prompts the driver to chat to avoid mental fatigue such that drowsy driving can be effectively prevented.

### BRIEF DESCRIPTION OF THE DRAWINGS

FIG. 1 is a schematic view illustrating a proactive chatting apparatus installed inside the car according to the first embodiment of the present invention;

FIG. 2 is a block diagram illustrating a proactive chatting apparatus according to the first embodiment of the present invention;

FIG. 3 is a block diagram illustrating a topic database connected by a chatting topic choosing device according to the first embodiment of the present invention;

FIG. 4 is a block diagram illustrating a topic database of a proactive chatting apparatus according to the second embodiment of the present invention.

### DETAILED DESCRIPTION OF THE PREFERRED EMBODIMENTS

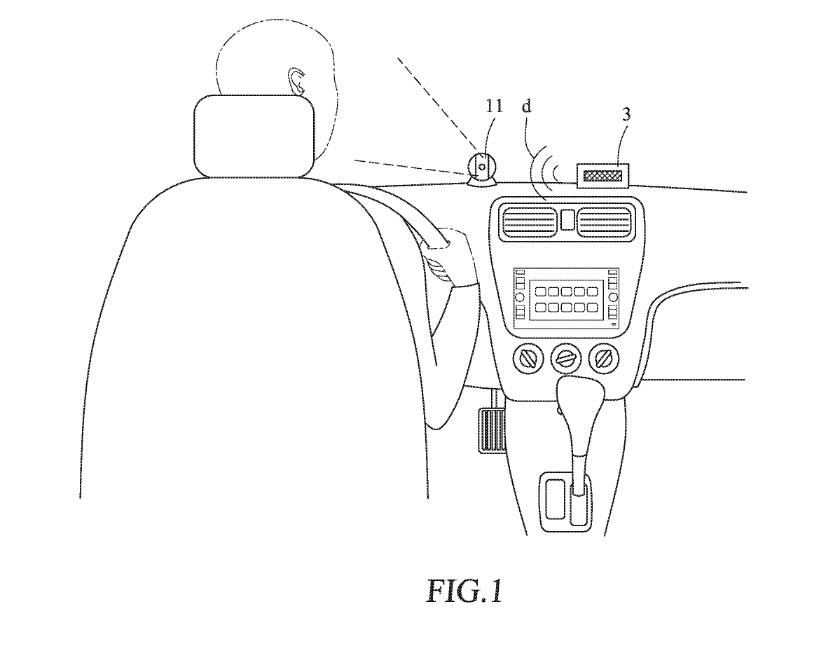

The preferred embodiments of the present invention are described in detail below with reference to FIG. 1 to FIG. 4. The description is used for explaining the embodiments of the present invention only, but not for limiting the scope of the claims.

As shown in FIG. 1 to FIG. 3, a proactive chatting apparatus 100 according to one embodiment of the present invention can proactively propose a voice signal to a user U so as to proactively initiate a chat conversation with the user, the proactive chatting apparatus 100 comprising: a chat activation determining device 1 determining whether a proactive chatting state is to be activated according to a facial expression image of the user or a user command C from the user such that, when the chat activation determining device 1 determines that the current status is a chat activation state, a proactive chatting signal S is sent; a topic selecting device 2 that grabs topic data Dx of a topic item I from a topic database D after the proactive chatting signal S is received; and a voice transceiver device 3 being connected to the topic selecting device 2 to receive the topic data Dx grabbed by the topic selecting device 2 so as to proactively transmit the topic data Dx to the user in way of voice, and receive a voice response R from the user U in response to the topic data Dx in such a manner that a chat conversation with the user is continued, wherein the topic items I in the topic database D are ones selected from a group comprising a current event item I1, a life background item I2, a travel destination item I3, a hobby item I4, a knowledge-acquiring item I5, a group instant-messaging topic item I6 and a surrounding environment instant user topic item I7.

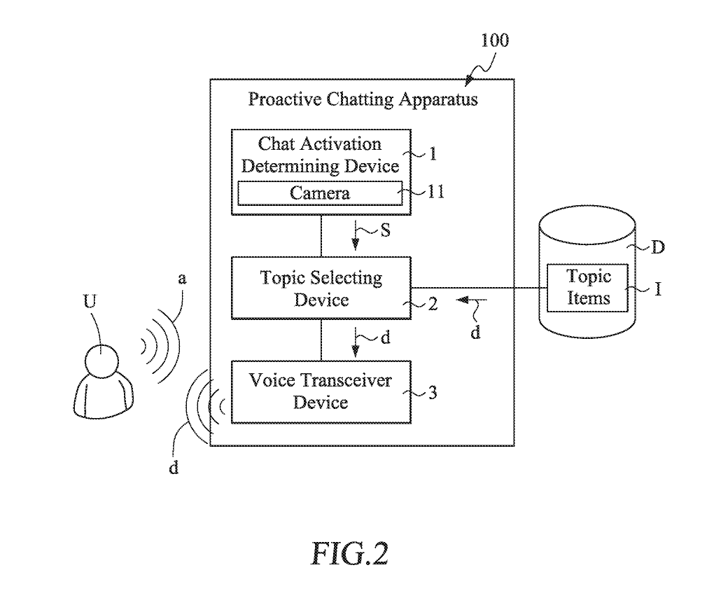

As shown in FIG. 1 and FIG. 2, the proactive chatting apparatus 100 of the first embodiment of the present invention is installed inside a car. Of course, the present invention is not limited to this. The proactive chatting apparatus can be used in places, such as at home, in public places, or be installed in a smart device. In the proactive chatting apparatus 100, the chat activation determining device 1 is provided with a camera 11 to obtain a facial expression image of the user, and then the obtained facial expression image of the user is then stored in a memory. The chat activation determining device 1 extracts facial expression images of the user which are identified by a processor and perform a recognition operation to determine whether the proactive chatting state is to be activated. In this embodiment, the chat activation determining device 1 can activate the proactive chatting state, and send a proactive chatting signal S when determining the facial expression of the user via the processor as “user getting bored”, “user in neutral facial expression”, “user getting tired”, “head is nodding”, “yawning” or “rubbing eyes” along with the changing degrees of eyes, mouth or face set by system default. On the contrary, when the user is with other facial expressions, the proactive chatting state is not to be activated. For example, the proactive chatting state is activated when the proactive chatting apparatus 100 determines that the user is in a state of feeling sleepy while the proactive chatting apparatus 100 detects that “the eyes are getting smaller”, “the eyes are continuously blinking”, “the eyes and the mouth have not moved for a period of time”, “the facial expression does not changed for a period of time”, “the head is nodding continuously”, “yawning” or “rubbing eyes”. In another embodiment, the chat activation determining device 1 can also activate the proactive chatting state and send a proactive chatting signal S according to a user command, such as a voice command or a button command given by the user U.

In this embodiment, when the proactive chatting state is activated, the chat activation determining device 1 can also determine via the processor whether the proactive chatting state is to be terminated according to the user facial expression image of the user U obtained by the camera 11 or according to the user command C from the user U, such as the voice command or the button command given by the user U so as to terminate the chat conversation. For example, when the user U gives a voice command by saying like “Got it” or “Talk to you later”, the chat activation determining device 1 terminates the proactive chatting state to terminate the chat conversation.

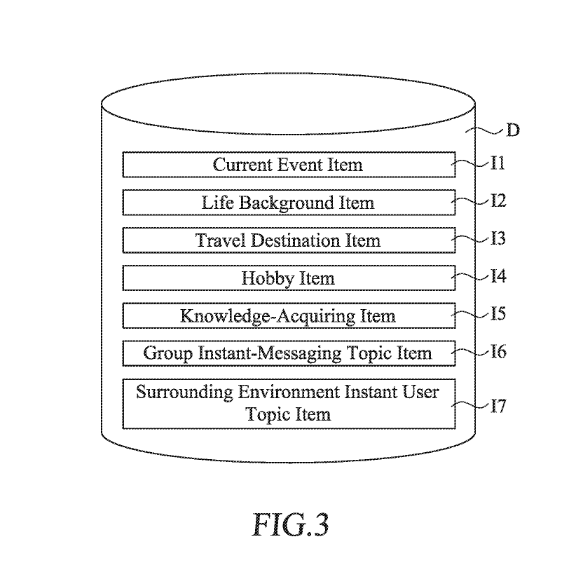

As shown in FIG. 2 and FIG. 3, the topic selecting device 2 grabs a topic data Dx of a topic item I from a topic database D after the proactive chatting signal S is received, and then stores the topic data Dx in the memory. In this embodiment, the topic database D is a cloud database that stores text data and voice data. In the other embodiment, the topic database D can also be a database stored in the proactive chatting apparatus of the present invention.

The selection of the topic items I can be performed according to the data such as personal data, location of the user U, keywords searched by the user U, internet browsing history, popular keywords, and current events. Accordingly, one or more than one related items are selected as the topic items I from a group in the topic database D including a current event item I1, a life background item I2, a travel destination item I3, a hobby item I4, a knowledge-acquiring item I5, a group instant-messaging topic item I6 and a surrounding environment instant user topic item I7. The current event item I1 includes current events data, such as social events, international situation, and financial trends. The life background item I2 includes data such as family information and life course. The travel destination item I3 includes data such as navigation data of destination and tourist spots around destination. The hobby item I4 includes data such as community experience and new knowledge in the field. The knowledge-acquiring item I5 includes data such as language learning data and new knowledge for health. The group instant-messaging topic item I6 includes internet popular keywords. The surrounding environment instant user topic item I7 includes data such as nearby people information and real time traffic information.

For example, the topic selecting device 2, based on the internet browsing history of the user U, determines, via the processor, that the user is interested in ball games. Then the topic selecting device 2 combines the current event to select “ball game schedules and results” as a topic item I. The topic item I includes topic data Dx in the current event item I1 and topic data Dx in the hobby item I4. Accordingly, the proactive chatting apparatus 100 can be personalized for the user U such that a suitable chatting topic can be selected.

The voice transceiver device 3 proactively sends the topic data Dx mentioned above to the user U in way of voice, and receives a voice response R from the user U in response to the topic data Dx and stores the voice response R to the memory in such a manner that a chat conversation with the user U is continued. In detail, the voice transceiver device 3 performs a speech recognition on the voice response of the user via the processor, and then continues to grab topic data Dx from the topic database D according to speech recognition result of the voice response such that the chat conversation with the user U is continued.

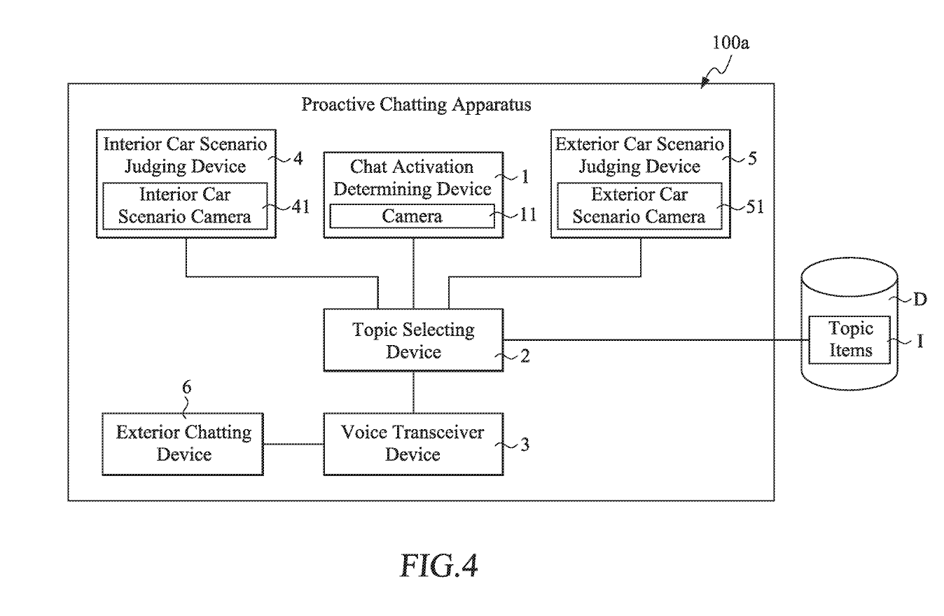

As shown in FIG. 4, the proactive chatting apparatus 100a according to the second embodiment of the present invention includes an interior car scenario judging device 4 and an exterior car scenario judging device 5. The interior car scenario judging device 4 is provided with an interior car scenario camera 41 to obtain an interior car image inside a car, and the interior car image is then stored in the memory. The exterior car scenario judging device 5 is provided with an exterior car scenario camera 51 to obtain an exterior car image outside the car, and the exterior car image is then stored in the memory. Under the proactive chatting state, the topic selecting device 2 identifies the stored interior car image and/or exterior car image via the processor, and grabs topic data Dx of the topic item I from the topic database D according to the identified interior car image and/or exterior car image. In detail, the topic item I grabbed by the topic selecting device 2 is transferred to build the connection with the surrounding environment instant user topic item I7, such as topic data Dx in relation to changes inside/outside the car and real-time traffic information. For example, according to the facial expression change of a baby in the interior car image, the voice transceiver device 3 plays voices like “the baby is hungry/is thirsty/has woken up”. Alternatively when a specific restaurant is appeared in the exterior car image at meal time, the voice transceiver device 3 proactively initiates a chat conversation with the user by playing voice to ask, “have you already tried the signature dish of the restaurant at your forward right? How about having the meal here?” Furthermore, in the other embodiment, the interior car scenario judging device 4 or the exterior car scenario judging device 5 can be installed solely to monitor only the situation inside or outside the car.

As shown in FIG. 4, an exterior chatting device 6 is connected to the voice transceiver device 3 to receive a voice signal from other users outside the car, such as a phone call signal and a radiotelephony signal. The voice transceiver device 3 plays the voice signal to the user in way of voice such that the user can initiate the chat conversation with other users outside the car through the voice transceiver device 3 and the exterior chatting device 6.

All the determinations and calculations mentioned above can be performed by a common processor, and in other embodiments, can be also performed by a processor configured in each device.

The above description should be considered only as an explanation of the preferred embodiment of the present invention. A person with ordinary skill in the art can make various modifications to the present invention based on the scope of the claims and the above description. However, those modifications shall fall within the scope of the present invention.

What is claimed is:

1. A proactive chatting apparatus adapted for use to proactively propose a voice signal to a user so as to initiate a chat conversation with the user, the proactive chatting apparatus comprising:
a chat activation determining device determining whether a proactive chatting state is to be activated according to a facial expression image of the user or a user command from the user such that, when the chat activation determining device determines the current status as a chat activation state, a proactive chatting signal is sent;
a topic selecting device grabbing topic data of a topic item from a topic database according to the proactive chatting signal; and
a voice transceiver device being connected to the topic selecting device to receive the topic data grabbed by the topic selecting device so as to proactively play the topic data to the user in way of voice, and receive a voice response from the user in response to the topic data in such a manner that a chat conversation with the user is continued,
wherein the topic items in the topic database are ones selected from a group comprising a current event item, a life background item, a travel destination item, a hobby item, a knowledge-acquiring item, a group instant-messaging topic item and a surrounding environment instant user topic item.

2. The proactive chatting apparatus of claim 1, wherein the chat activation determining device is provided with a camera to obtain the facial expression image of the user.

3. The proactive chatting apparatus of claim 1, wherein the user command is a voice command or a key command.

4. The proactive chatting apparatus of claim 1, further comprising an interior car scenario judging device which is provided with an interior car scenario camera to obtain an interior car image inside a car where the user is, the topic selecting device grabbing the topic data of the topic item from the topic database according to the interior car image.

5. The proactive chatting apparatus of claim 1, further comprising an exterior car scenario judging device which is provided with an exterior car scenario camera to obtain an exterior car image outside the car where the user is, the topic selecting device grabbing the topic data of the topic item from the topic database according to the exterior car image.

6. The proactive chatting apparatus of claim 1, wherein the topic data includes a plurality of topic data, and the plurality of topic data are related to each other.

7. The proactive chatting apparatus of claim 1, wherein the chat activation determining device determines whether the proactive chatting state is to be terminated according to the user facial expression image of the user or according to the user command from the user so as to terminate the chat conversation.

8. The proactive chatting apparatus of claim 1, further comprising an exterior chatting device which receives a voice signal from other users outside the car where the user is so as to initiate the chat conversation between the user and said other users.
